(19) United States
(12) Patent Application Publication
(10) Pub. No.: US 2014/0164238 A1
(43) Pub. Date: Jun. 12, 2014

(54) Concurrent Servicing of Multiple Processing Requests

(71) Applicant: Timo Hoyer, Mountain View, CA (US)

(72) Inventor: Timo Hoyer, Mountain View, CA (US)

(73) Assignee: SAP AG, Walldorf (DE)

(21) Appl. No.: 13/712,706

(22) Filed: Dec. 12, 2012

(51) Int. Cl. G06F 3/0482

(52) U.S. Cl. CPC G06F 3/0482
USPC 705/44; 715/835

(57) ABSTRACT

Example systems and methods of concurrent servicing of multiple processing requests are presented. In one example, a plurality of first graphical objects representing processing requests are displayed in a first area of a display. Each of the first graphical objects presents information concerning its corresponding processing request. In response to selection of more than one of the first graphical objects, a plurality of second graphical objects corresponding to the selected first graphical objects are displayed in a second area of the display. Each of the second graphical objects presents second information having a greater level of detail than that of the first information of the corresponding first graphical object. A user-selectable region associated with the second graphical objects is also displayed. In response to a user selection of the user-selectable region, the processing requests associated with the second graphical objects are serviced.

### BACKGROUND

Within many organizations, such as corporations and other business-oriented entities, managers are often tasked with approving (or otherwise processing) requests or other interrogatories from other employees within the organization. Such employees may be direct or indirect reports of the manager, or may be associated with the manager in some other capacity. Such requests may include, for example, purchase requests, requests for services, requests for vacation time scheduling, and others. Typically, the manager may review each request at some level of detail, and then either approve or deny each request in isolation according to the professional judgment of the manager before processing another request. In some situations, the manager may request more information from the requester before making a final determination on a request.

### BRIEF DESCRIPTION Of DRAWINGS

The present disclosure is illustrated by way of example and not limitation in the figures of the accompanying drawings, in which like references indicate similar elements and in which:

FIG. 1 is a block diagram of an example system having a client-server architecture for an enterprise application platform capable of engaging with the systems and methods described herein;

FIG. 2 is a block diagram of example applications and modules employable in the enterprise application platform of FIG. 1;

FIG. 3 is a block diagram of an example client device for concurrent servicing of multiple processing requests;

FIG. 4 is a flow diagram illustrating an example method of concurrent servicing of multiple processing requests;

FIG. 5A is an example screenshot of a client device display in which one graphical object for a single processing request is selected for possible servicing;

FIG. 5B is an example screenshot of a client device display in which two graphical objects for corresponding processing requests are selected for possible servicing;

FIG. 5C is an example screenshot of a client device display in which three graphical objects for corresponding processing requests are selected for possible servicing;

FIG. 5D is an example screenshot of a client device display in which one of the three graphical objects for corresponding processing requests is selected once more to provide additional information regarding the processing request; and

FIG. 6 is a block diagram of a machine in the example form of a processing system within which may be executed a set of instructions for causing the machine to perform any one or more of the methodologies discussed herein.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction, instances, protocols, structures, and techniques have not been shown in detail.

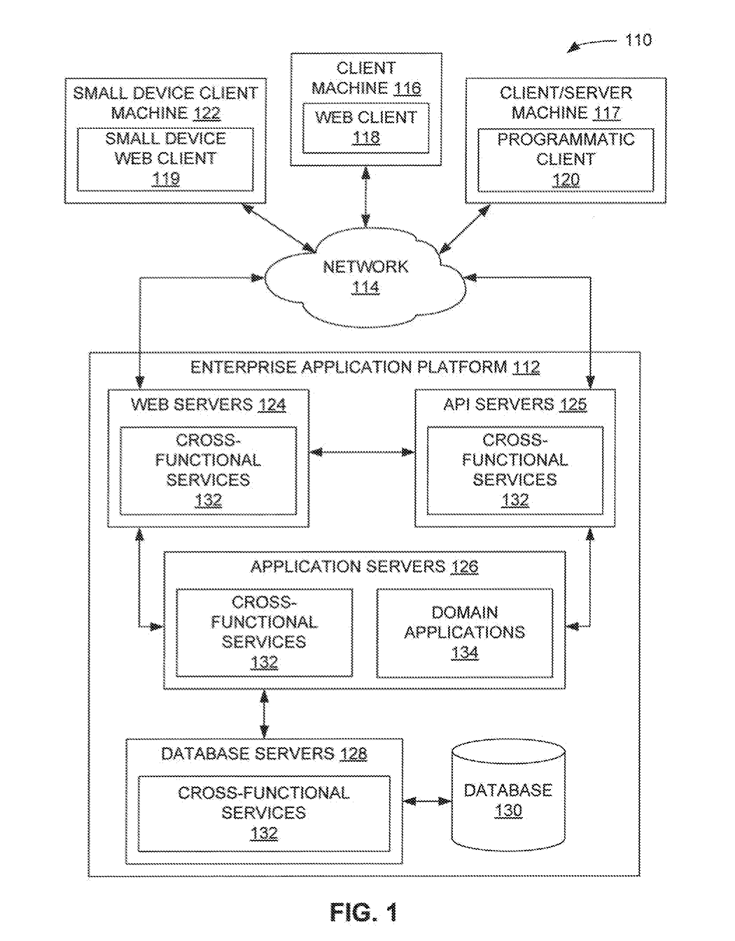

FIG. 1 is a network diagram depicting an example system 110, according to one exemplary embodiment, having a client-server architecture configured to engage with the various methods described herein. A platform (e.g., machines and software), in the exemplary form of an enterprise application platform 112, provides server-side functionality via a network 114 (e.g., the Internet) to one or more clients. FIG. 1 illustrates, for example, a client machine 116 with a web client 118 (e.g., a browser, such as the Internet Explorer® browser developed by Microsoft® Corporation), a small device client machine 122 with a small device web client 119 (e.g., a browser without a script engine), and a client/server machine 117 with a programmatic client 120.

Turning specifically to the enterprise application platform 112, web servers 124 and application program interface (API) servers 125 are coupled to, and provide web and programmatic interfaces to, application servers 126. The application servers 126 are, in turn, shown to be coupled to one or more database servers 128, which may facilitate access to one or more databases 130. The web servers 124. API servers 125, application servers 126, and database servers 128 may host cross-functional services 132. The application servers 126 may further host domain applications 134.

The cross-functional services 132 may provide user services and processes that utilize the enterprise application platform 112. For example, the cross-functional services 132 may provide portal services (e.g., web services), database services, and connectivity to the domain applications 134 for users that operate the client machine 116, the client/server machine 117, and the small device client machine 122. In addition, the cross-functional services 132 may provide an environment for delivering enhancements to existing applications and for integrating third-party and legacy applications with existing cross-functional services 132 and domain applications 134. Further, while the system 110 shown in FIG. 1 employs a client-server architecture, the present disclosure is, of course, not limited to such an architecture, and could equally well find application in a distributed or peer-to-peer architecture system.

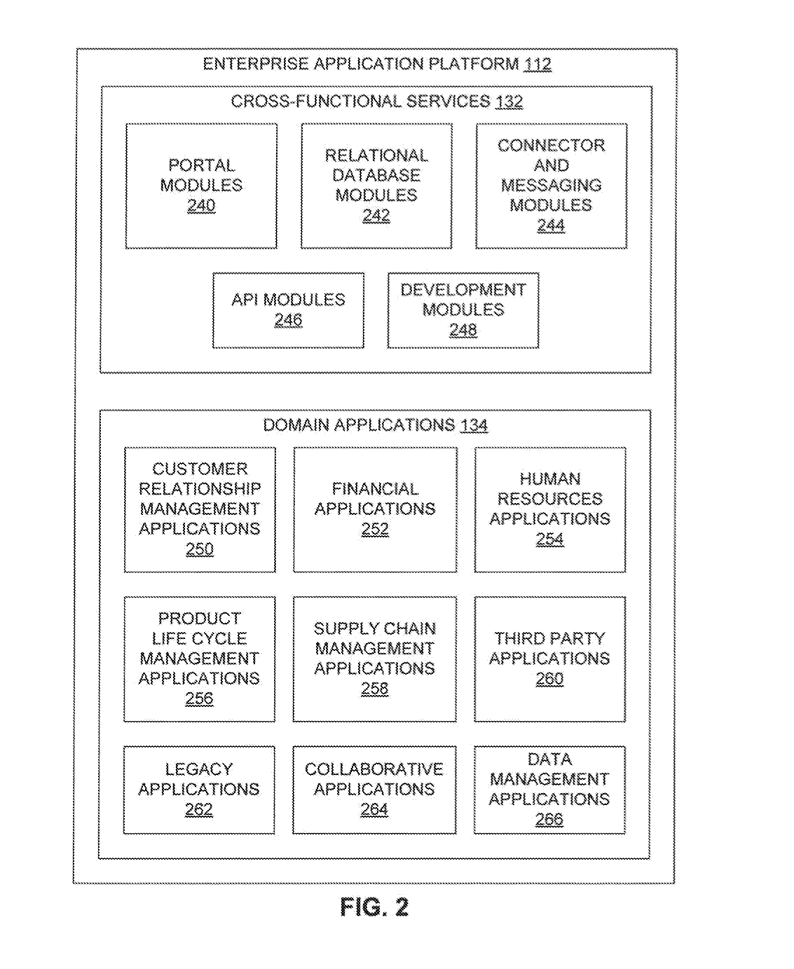

FIG. 2 is a block diagram illustrating example enterprise applications and services, such as those described herein, as embodied in the enterprise application platform 112, according to an exemplary embodiment. The enterprise application platform 112 includes cross-functional services 132 and domain applications 134. The cross-functional services 132 include portal modules 240, relational database modules 242, connector and messaging modules 244, API modules 246, and development modules 248.

The portal modules 240 may enable a single point of access to other cross-functional services 132 and domain applications 134 for the client machine 116, the small device client machine 122, and the client/server machine 117 of FIG. 1. The portal modules 240 may be utilized to process, author, and maintain web pages that present content (e.g., user interface elements and navigational controls) to the user. In addition, the portal modules 240 may enable user roles, a construct that associates a role with a specialized environment that is utilized by a user to execute tasks, utilize services, and exchange information with other users and within a defined scope. For example, the role may determine the content that is available to the user and the activities that the user may perform. The portal modules 240 may include, in one implementation, a generation module, a communication module, a receiving module, and a regenerating module. In addition, the portal modules 240 may comply with web services standards and/or utilize a variety of Internet technologies, including, but not limited to, Java®, Java 2 Platform—Enterprise Edition (J2EE), SAP's Advanced Business Application Programming (ABAP®) Language and Web Dynpro, eXtensible Markup Language (XML). Java Connector Architecture (JCA), Java Authentication and Authorization Service (JAAS), X.509, Lightweight Directory Access Protocol (LDAP), Web Services Description Language (WSDL), WebSphere Service Registry and Repository (WSRR), Simple Object Access Protocol (SOAP), Universal Description, Discovery and Integration (UDDI), and Microsoft .NET.

The relational database modules 242 may provide support services for access to the database 130 (FIG. 1) that includes a user interface library. The relational database modules 242 may provide support for object relational mapping, database independence, and distributed computing. The relational database modules 242 may be utilized to add, delete, update, and manage database elements. In addition, the relational database modules 242 may comply with database standards and/or utilize a variety of database technologies including, but not limited to, Structured Query Language (SQL), SQL Database Connectivity (SQLDBC), Oracle®, MySQL, Unicode, and Java Database Connectivity (JDBC).

The connector and messaging modules 244 may enable communication across different types of messaging systems that are utilized by the cross-functional services 132 and the domain applications 134 by providing a common messaging application processing interface. The connector and messaging modules 244 may enable asynchronous communication on the enterprise application platform 112.

The API modules 246 may enable the development of service-based applications by exposing an interface to existing and new applications as services. Repositories may be included in the platform 112 as a central place to find available services when building applications.

The development modules 248 may provide a development environment for the adding, integrating, updating, and extending of software components on the enterprise application platform 112 without impacting existing cross-functional services 132 and domain applications 134.

Turning to the domain applications 134, customer relationship management applications 250 may enable access to, and facilitate collecting and storing of, relevant personalized information from multiple data sources and business processes. Enterprise personnel who are tasked with developing a buyer into a long-term customer may utilize the customer relationship management applications 250 to provide assistance to the buyer throughout a customer engagement cycle.

Enterprise personnel may utilize financial applications 252 and business processes to track and control financial transactions within the enterprise application platform 112. The financial applications 252 may facilitate the execution of operational, analytical, and collaborative tasks that are associated with financial management. Specifically, the financial applications 252 may enable the performance of tasks related to financial accountability, planning, forecasting, and managing the cost of finance.

Human resources applications 254 may be utilized by enterprise personnel and business processes to manage, deploy, and track enterprise personnel. Specifically, the human resources applications 254 may enable the analysis of human resource issues and facilitate human resource decisions based on real-time information.

Product life cycle management applications 256 may enable the management of a product throughout the life cycle of the product. For example, the product life cycle management applications 256 may enable collaborative engineering, custom product development, project management, asset-management, and quality management among business partners.

Supply chain management applications 258 may enable monitoring of performances that are observed in supply chains. The supply chain management applications 258 may facilitate adherence to production plans and on-time delivery of products and services.

Third-party applications 260, as well as legacy applications 262, may be integrated with domain applications 134 and utilize cross-functional services 132 on the enterprise application platform 112.

Additionally, collaborative applications 264 may facilitate joint creation and modification of documents and other work product by multiple users, and data management applications 266 may enable data organization and other management functions to be performed on data generated by one or more other domain applications 134.

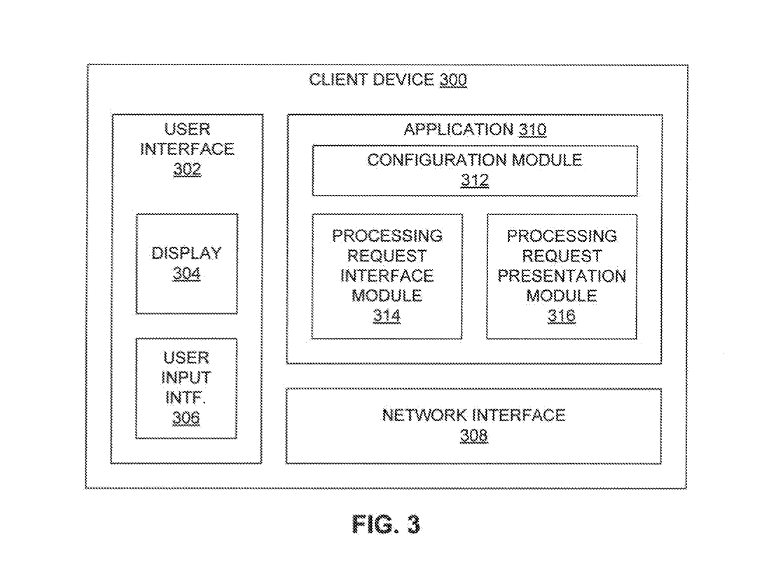

FIG. 3 is a block diagram of an example client device 300 for concurrent servicing of multiple processing requests. In some examples, the client device 300 may be any of client machines 116, 117, and 122 of FIG. 1, and thus may communicate via the network 114 to the enterprise application platform 112 of FIG. 1. More specifically, the client device 300 may receive processing requests via the enterprise application platform 112 from one or more other client machines 116, 117, and 122, and may indicate the processing or servicing of those requests via the network 114. In other examples, the client device 300 may receive processing requests directly from other client devices via a communication network. In some examples, the processing requests may be originated by employees or other members of a particular corporation or organization utilizing the enterprise application platform 112. In such cases, the client device 300 receiving the processing requests may be utilized by a manager or other person or entity charged with processing the requests.

In some examples, the processing requests may be request for approval of purchase orders, such as for office equipment to be employed by the requesting employee or others in the performance of work duties. In other implementations, the processing requests may be requests for approval of vacation time to be taken by the requestor during a particular time period. Many other examples of processing requests are also possible, both within and external to the corporate context.

The client device 300 may be a personal computer (PC), a laptop computer, a tablet computer, a smart phone, a personal digital assistant (PDA), or any other communication device that a user may employ to process requests, as described herein. As shown in FIG. 3, the client device 300 may include a user interface 302, a network interface 308, and an application 310 to be executed by one or more processors of the client device 300. Other components that may be included, such as the aforementioned processors, memory, and the like, are not explicitly shown in FIG. 3 to simplify and focus the following discussion.

The user interface 302 of the client device 300 may include a display 304 and a user input interface 306. In some examples, such as those described more fully below, the display 304 and the user input interface 306 may be combined into a signal electronic component, such as a touchscreen that may be provided in a tablet computer or smart phone. In other examples, the display 304 may be a liquid crystal display (LCD) monitor or other type of display that does not incorporate a user input interface, while the user input interface 306 may include a keyboard, keypad, mouse, touchpad, and/or other devices for receiving user input.

The network interface 308 may be any interface facilitating communication between the client device 300 and other communication devices or systems, such as the enterprise application platforms 112 of FIG. 1, possibly via a communication network, such as the network 114 of FIG. 1. In the example of a tablet computer, smart phone, or other portable communication device, the network interface 308 may be a wireless communication interface, such as a Wi-Fi (IEEE 802.11b/g/n) interface, cellular 3G or 4G interface, Bluetooth® interface, or the like. Further, the network 114 may be a wide-area network (WAN) (e.g., the Internet or an Intranet), a local-area network (LAN), a cell phone network (e.g., a 3G or 4G network), a Bluetooth® connection, or some other communication network, including combinations thereof.

The application 310 may be any application executable on the client device 300 that is configured to receive processing requests via the network interface 308 and allow a user of the client device 300 to process the received requests in some manner. In other examples, the application 310 may be a web browser or other communication application that interacts with a server or other device via the network interface 308 to receive and process the requests. In yet other embodiments, the application 310 may operate as part of a larger communication application, such as an email application, through which the application 310 may receive the processing requests. Other forms of the application 310 that are capable of receiving processing requests and facilitating the processing of those requests by the user of the client device 300 may be employed in other implementations.

As depicted in FIG. 3, the application 310 may include, for example, a configuration module 312, a processing request interface module 314, and a processing request presentation module 316. The processing request interface module 314 may be configured to receive multiple processing requests, such as purchase requests, vacation time requests, and the like, tram other systems, such as the enterprise application platform 112 of FIG. 1, via the network interface 308. The processing request interface module 314 may also indicate the subsequent servicing or processing of the requests via the network interface 308 to other devices or systems, such as the enterprise application platform 112.

The processing request presentation module 316 may display, concurrently or simultaneously, multiple processing requests from one or more other users or entities via the display 304, as well as facilitate the processing (e.g., approval) of multiple ones of the requests by a user of the client device 300 via the user input interface 306. Further, the processing request presentation module 316 may display, upon selection by the user, additional information regarding multiple ones of the processing requests to facilitate a decision by the user regarding the processing of the requests.

The configuration module 312 of the application 310 may receive user input via the user input interface 306 to configure one or more aspects of the application 310. In one implementation, the configuration module 312 may receive selections regarding the location on the display 304 at which the processing requests are displayed, the types and/or amount of information being displayed for each of the requests, and so on.

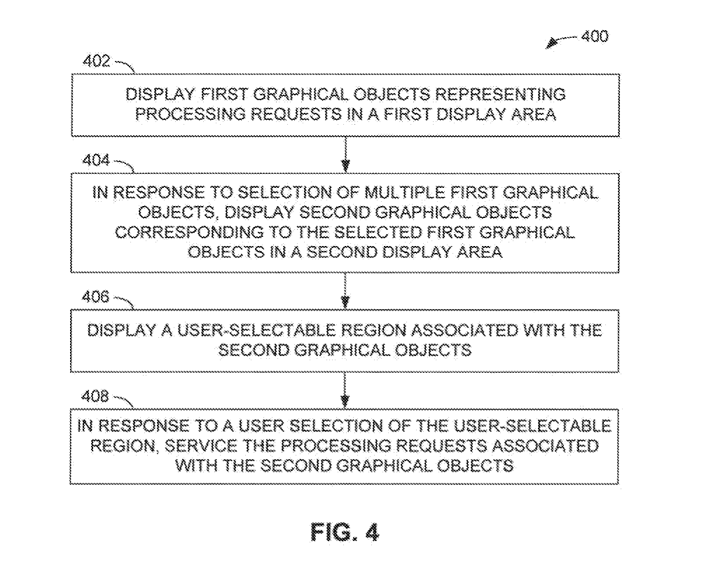

FIG. 4 is a flow diagram illustrating an example method 400 of concurrent servicing of multiple processing requests. While the various operations of the method 400 are described in reference to the client device 300 of FIG. 3, other devices or systems may be employed to perform the method 400 in other embodiments.

In the method 400, the processing request presentation module 316 may display first graphical objects, each of which represents a particular processing request, in a first display area of the display 304 (operation 402). In one example, the first graphical objects are presented in a list format, although other forms of presentation are possible in other implementations. Also, each of the first graphical objects may provide information regarding its corresponding processing request at a first level of detail.

In response to a selection of multiple first graphical objects, such as by way of the user input interface 306, the processing request presentation module 316 may display second graphical objects corresponding to the selected first graphical objects in a second display area of the display 304 that is different from the first display area (operation 404). In at least some examples, the amount of information provided by each of the second graphical objects is at a second level higher than that of the first level of detail associated with the first graphical objects.

The processing request presentation module 316 may also present, via the display 304, a user-selectable region associated with the second graphical objects (operation 406). Depending on the nature of the particular user input interface 306 being employed, the user may either select the user-selectable region by touching the associated portion of the display 304 (in the case of a touchscreen), or by activating the region via a mouse click, or via other means. In response to the user selecting the user-selectable region, the processing requests associated with the second graphical objects may then be serviced (operation 408). In one example, servicing of the processing requests may include approval of each of the processing requests of the second graphical objects.

While the operations 402 through 408 of the method 400 of FIG. 4 are shown in a specific order, other orders of operation, including possibly concurrent or continual execution of at least portions of one or more operations, may be possible in some implementations of method 400, as well as other methods discussed herein. For example, the displaying of the second graphical objects (operation 404) and the displaying of the user-selectable region (operation 406) may occur concurrently or simultaneously.

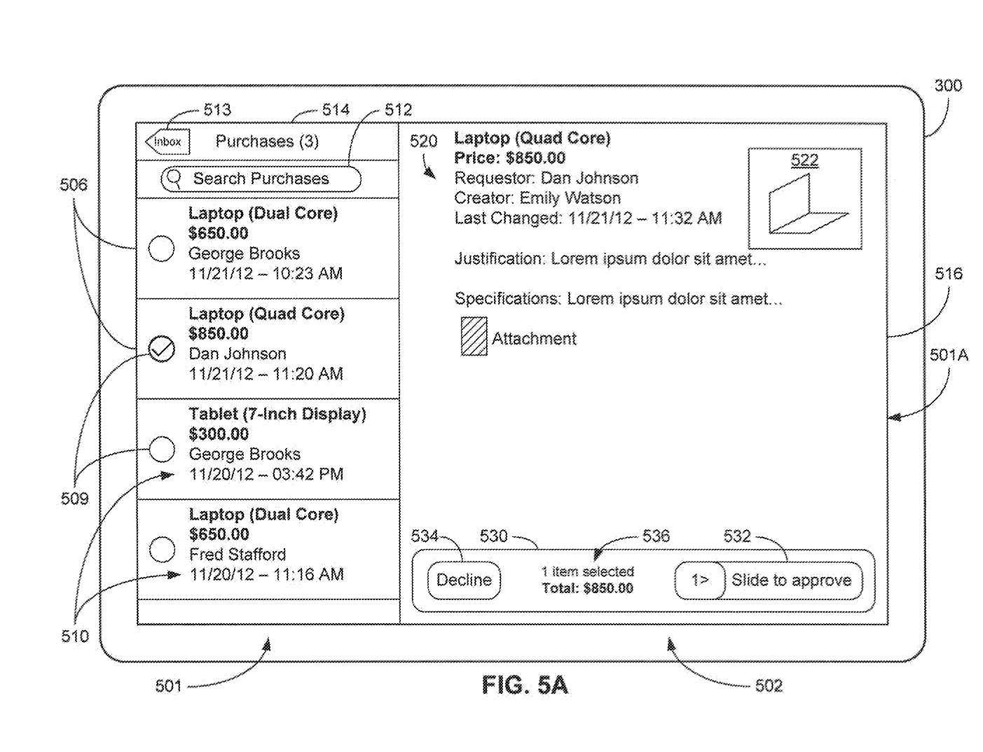

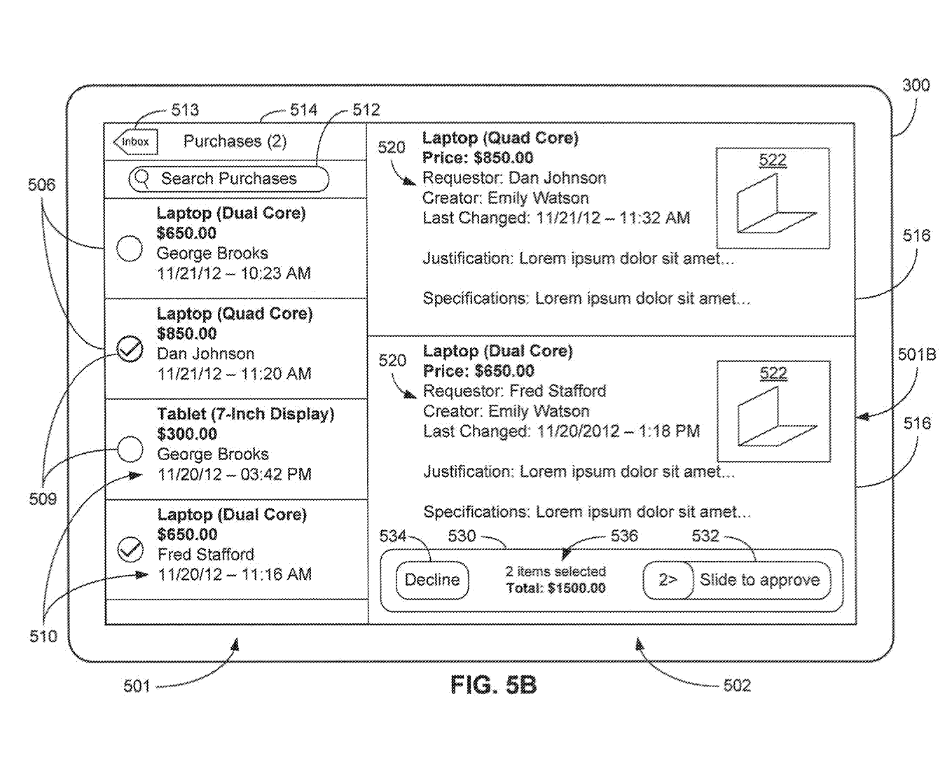

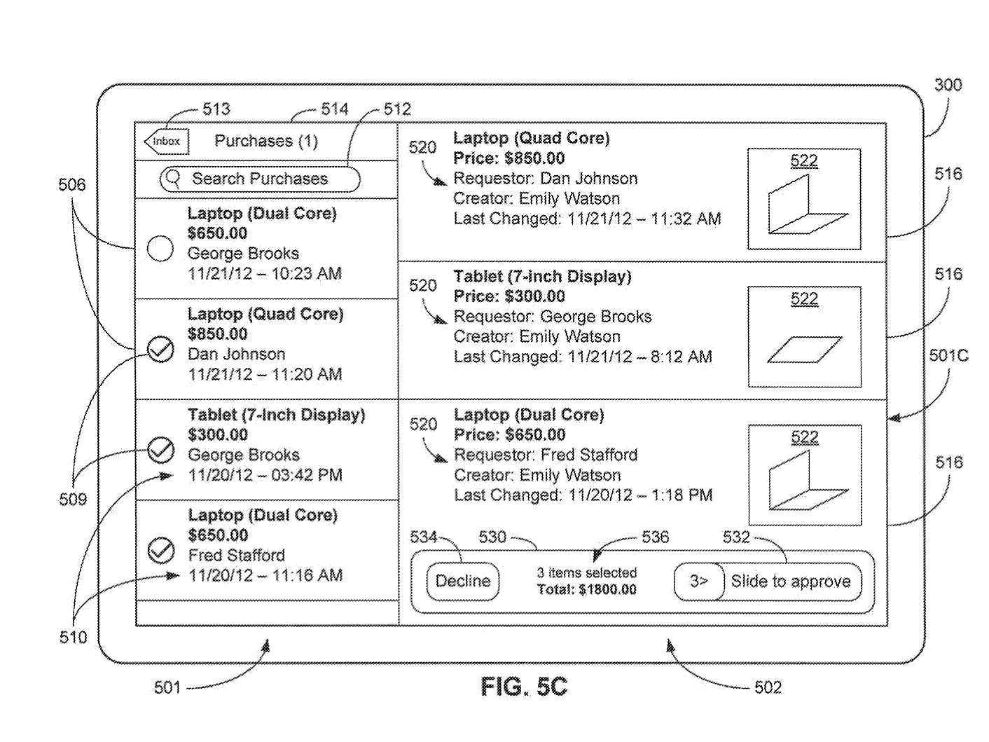

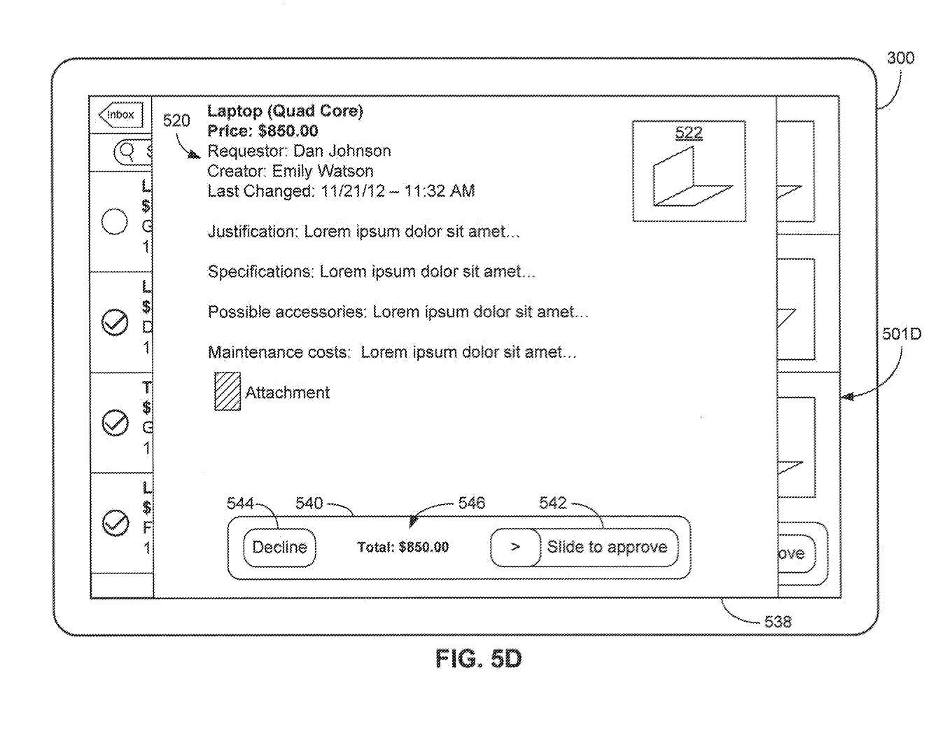

FIGS. 5A through 5D illustrate example screenshots of the display 304 of the client device 300 according to a particular embodiment of concurrent servicing of multiple processing requests, as described herein. These example screenshots illustrate a scenario in which multiple purchase requests for computer equipment have been made on behalf of multiple employees of an organization. Accordingly, the user of the client device 300 may be viewed as a manager or other employee whose responsibility is to approve or decline each of the purchase requests. In one example, the processing request presentation module 316 may format and present each of the screenshots for viewing on the display 304 of the client device 300.

FIG. 5A is an example screenshot 501A of the display 304 of the client device 300 in which multiple first graphical objects 506 are displayed in a first display area 501. In this particular example, the first graphical objects 506 are shown as boxes in a list, arranged beginning with the earliest submitted purchase request (e.g., a dual core laptop purchase request for George Brooks). Additionally, each of the first graphical objects 506 includes first information 510, such as the item of electronic equipment to be purchased, the cost of the item, the employee for whom the equipment is to be purchased, and the date and time at which the purchase request was submitted. In other examples, each of the first graphical objects 506 may include more, less, or different information than the first information 510 depicted in FIG. 5A.

Also, each of the first graphical objects 506 includes a user-selectable area 509 that, when selected by the user of the client device 300, causes a corresponding second graphical object 516 to be displayed in a second display area 502. In the specific example of FIG. 5A, a single first graphical object 506 representing a purchase request for a quad core laptop for Dan Johnson is selected, as noted by the checkmark in the user-selectable area 509 included therein. In response, a second graphical object 516 associated with the selected first graphical object 506 is presented in the second display area 502. As shown, the second graphical object 516 includes second information 520, which provides more information than the first information 510 provided in the corresponding first graphical object 506. More specifically, in addition to the item to be purchased, the item cost, and the requestor of the item, the second graphical object 516 may include a name of the creator of the request (e.g., Emily Watson), the date and time at which the request was last updated, a justification for the request, specifications for the item, an icon or image 522 of the item, and one or more file attachments that may provide more information regarding the item to be purchased. In other examples, additional, or different types of information may be displayed in the second graphical object 516.

As shown in FIG. 5A, the first display area 501 occupies a left-hand area of the display 304, while the second display area 502 occupies a greater area on the right-hand section of the display 304. However, the first display area 501 and the second display area 502 may be arranged differently on the display 304, and occupy different portions of the display 304, in other implementations.

Depending on the particular embodiment, the first selection of one of the first graphical objects 506 may be performed by a user of the client device 300, or may be a default selection provided by the processing request presentation module 316. If a default selection is made, the processing request presentation module 316 may base the selection on one or more factors, such as those that may be indicated in the configuration module 312 of the application 310. In one example, such as that shown in FIG. 5A, the first graphical object 506 representing the highest-cost purchase request may be selected. Other factors, such as the date and time associated with the request, the identity of the requestor, and the like, may be considered in determining the default selection.

Similarly, the types and amount of information provided in both the first graphical objects 506 and the second graphical object 516 may be determined by the processing request presentation module 316, or by the user via the configuration module 312 of the application 310.

Based on the second information 520 presented in the selected graphical object 516 over the first information 510 provided in the corresponding first graphical object 506, the user of the client device 300 may be able to decide whether to approve or decline the request. To facilitate receiving input regarding such approval or denial, the processing request presentation module 316 may provide a decision area 530 on the display 304 that includes a first user-selectable region 532 by which the user may approve the purchase request. More specifically, the first user-selectable region 532 may indicate the number of requests (e.g., one, in this case) that will be approved by activating the first user-selectable region 532. In the particular example of FIG. 5A, the user may activate the first user-selectable region 532 by a swiping or sliding gesture from left to right. The decision area 530 may also include a second user-selectable region 534 that, when activated by the user, declines or denies the request. In the specific implementation of FIG. 5A, the user need only touch or tap the second user-selectable region 534, unlike the more complicated gesture used to activate the first user-selectable region 532, thus rendering approval a slightly more thoughtful operation than denial of the request. Further, whether the user has indicated approval or denial of the request, the processing request presentation module 316 may request further confirmation of the action, such as by way of an additional user-selectable region (not shown in FIG. 5A) presented to the user.

As depicted in FIG. 5A, the decision area 530 may also provide summary information 536 regarding the second graphical object 516. In this particular example, the summary information 536 indicates the number of items (e.g., first graphical objects 506) selected (e.g., one), as well as a total cost (e.g., $850,00) of the selected items. Additional or different information may be provided in the summary information 536 in other embodiments.

In response to the user activating either the first user-selectable region 532 or the second user-selectable region 534, the processing request interface module 314 may cause an indication of the activation to be transmitted via the network interface 308 over a communication network (e.g., the network 114 of FIG. 1) to another device or system (e.g., the enterprise application platform 112). In the case of approval, the transmission may initiate the servicing of the request (e.g., the purchase of the item indicated in the selected purchase request). If the request was declined, that fact may be indicated in the transmission as well. In the implementation of FIG. 5A, the decision area 530 is located within the second display area 502. in other examples, the decision area 530 could be placed anywhere else within the display 304.

As shown in FIG. 5A, the display 304 may also provide at least one of a folder label 514, a “back” button 513, and a search input field 512. The folder label 514 (e.g. “Purchases (3)”), as employed in FIG. 5A, may indicate a folder within a larger data structure in which the processing requests associated with the first graphical objects 506 may be located, possibly with a number of the processing requests that currently remain unselected for representation by second graphical objects 516 in the second display area 502. Further, the back button 513 may allow navigation from the currently viewed folder to a higher-level parent folder (e.g., “Inbox”). As a result, FIG. 5A may provide an example in which the purchasing requests being received are collected in a Purchases folder within a higher-level Inbox folder of an email application or other similar communication application. In addition, the search input field 512 may allow the user to enter one or more keywords to search for one or more particular processing requests to be represented by the first graphical objects 506.

In FIG. 5B, an example screenshot 501B of the display 304 of the client device is illustrated. in this example, the user of the client device 300 has selected a second one of the first graphical objects 506, as indicated by the second checked user-selectable area 509 associated with a purchase request for a dual core laptop for Fred Stafford. In the case of a touchscreen display 304, the user may make such a selection by merely tapping or touching the corresponding first graphical object 506 or, more specifically, the user-selectable area 509 located therein. In response, a second graphical object 516 associated with the second-selected first graphical object 506 may be displayed in the second display area 502 along with the previously provided second graphical object 516 associated with the quad core laptop. In the particular embodiment of FIG. 5B, the second display area 502 may be divided relatively equally between the two second graphical objects 516. Further, the two second graphical objects 516 may appear as virtual documents that overlap one another, or that reside as separate files within a virtual file cabinet. Alternative arrangements of the multiple second graphical objects 516 within the second display area 502 are also possible.

As a result of the additional second graphical object 516 being displayed, less of the second information 520 associated with each of the two second graphical objects 516 of FIG. 5B may be presented when compared to the second information 520 of the sole second graphical object 516 of FIG. 5A due to less available space within the second display area 502. However, the amount of the second information 520 presented in each of the second graphical objects 516 may remain greater than the amount of detail of the information 510 provided in the corresponding first graphical objects 506. In some implementations, the user may be allowed to alter the relative size of the second graphical objects 516 by, for example, manually extending or “stretching” a border of one of the second graphical objects 516 over an adjacent second graphical object 516. In other examples, the various second graphical objects 516 may be “flipped through,” like files in a virtual file cabinet, thus allowing the user to view more details of each.

In one example, the user of the client device 300 may alter the arrangement of the second graphical objects 516 manually relative to each other. Within the environment of FIG. 5B, the user may, for example, drag the lower second graphical object 516 above the upper second graphical object 516 so that the second graphical objects 516 essentially swap positions within the second display area 502.

Also in response to the selection of a second one of the first graphical objects 506, the processing request presentation module 316 may provide updated information in the decision area 530. For example, the number of second graphical objects 516 indicated in the first user-selectable region 532 may be updated, thus indicating that a user selection of the first user-selectable region 532 will result in concurrent or simultaneous approval of all of the processing (purchase) requests associated with the second graphical objects 516 in the second display area 502. Additionally, the summary information 536 of the decision area 530 may be updated to indicate that two of the processing requests are currently selected, with a total cost of $1500.00, thus providing the user an indication of the total financial impact of approving the selected processing requests. In some examples, the folder label 514 may also be updated to indicate the current number of the first graphical objects 506 currently remaining unselected (e.g., two).

FIG. 5C provide an example screenshot 501C of the display 304 of the client device 300 resulting from a user selection of a third one of the first graphical objects 516 (e.g., the purchase request for the seven-inch tablet). In response to that user selection, a second graphical object 516 representing a purchase request for the tablet is provided in the second display area 502 along with the two previously selected second graphical objects 516. As shown in FIG. 5C, the second information 520 presented in each of the second graphical objects 516 may be reduced as a result of the increased number of second graphical objects 516 being displayed while still providing more detail than the first information 510 of the corresponding first graphical objects 506 of the first display area 501. In addition, the folder label 514 may be updated in light of the third-presented second graphical object 516 to indicate that a single first graphical object 506 remains unselected. Also, the decision area 536 may be updated to indicate in the first user-selectable region 532 and the summary information 536 that three purchase requests may be approved. Further, the total cost of the selected purchase requests (e.g., $1800.00) may be reflected in the summary information 536. Accordingly, a user selection of the first user-selectable region 536 results in approval of the three purchase requests represented by the second graphical objects 516.

To allow the user of the client device 300 to peruse more details regarding one of processing requests associated with a second graphical object 516 than what is available via the example screenshot 501C of FIG. 5C, the user may select (e.g., by touching or tapping) the second graphical object 516 of interest, possibly resulting in the example screenshot 510D of FIG. 5D. In that example, the user selection of the second graphical object 516 (e.g., the quad core laptop for Dan Johnson) may result in a third graphical object 538 overlaying a large portion of the first display area 501 and the second display area 502 to present a maximal amount of the second information 520 from the associated second graphical object 516 that may be hidden due to multiple second graphical objects 516 being displayed in the second display area 502. In addition, a second decision area 540 may be displayed in conjunction with the third graphical object 538 that includes a first user-selectable region 542 to approve the request associated with the third graphical object 538, a second user-selectable region 544 for denying or declining the request, and summary information 546 that may indicate, for example, the cost of the proposed purchase. From the example screenshot 501D, the user may employ a return button (not explicitly shown in FIG. 5D) or tap the third graphical object 538 to return to the example screenshot 501C of FIG. 5C.

As a result of at least some of the embodiments described above, a user in charge of approving or otherwise processing requests (e.g., purchase requests, vacation time requests, etc.) from one or more sources may quickly select multiple such requests, review information regarding each request, and then process or deny the requests simultaneously or concurrently. Accordingly, the user may process the requests quickly using any type of communication device, including a mobile device, such as a PDA, a tablet computer, and a smart phone.

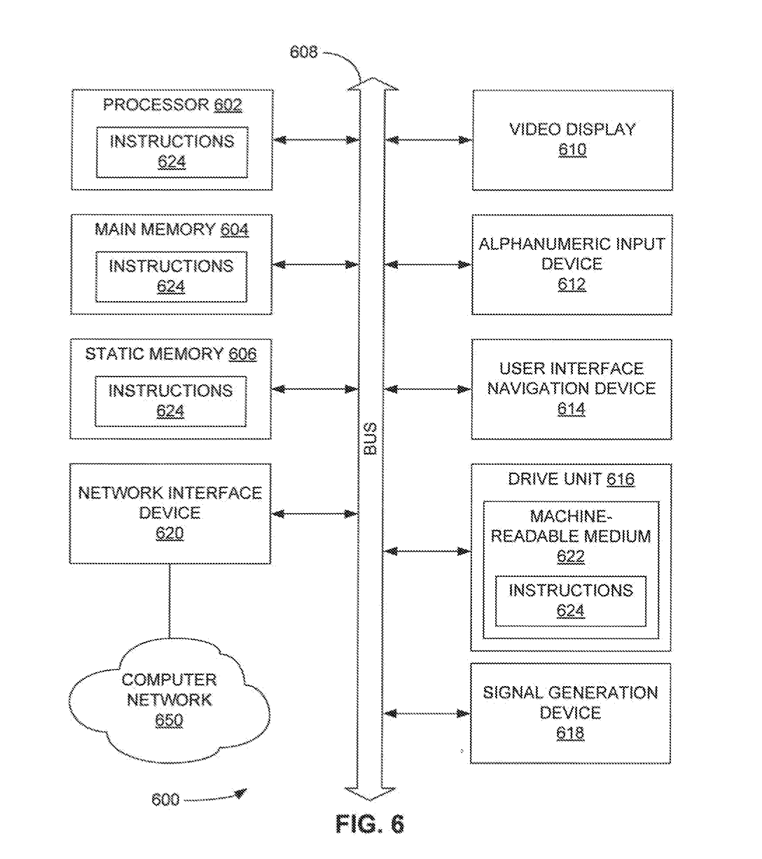

FIG. 6 depicts a block diagram of a machine in the example form of a processing system 600 within which may be executed a set of instructions 624 for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment.

The machine is capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example of the processing system 600 includes a processor 602 (e.g., a central processing unit (CPU), a graphics processing unit (GPU), or both), a main memory 604 (e.g., random access memory), and static memory 606 (e.g., static random-access memory), which communicate with each other via bus 608. The processing system 600 may further include video display unit 610 (e.g., a plasma display, a liquid crystal display (LCD), or a cathode ray tube (CRT). The processing system 600 also includes an alphanumeric input device 612 (e.g., a keyboard), a user interface (UI) navigation device 614 (e.g., a mouse), a disk drive unit 616, a signal generation device 618 (e.g., a speaker), and a network interface device 620.

The disk drive unit 616 (a type of non-volatile memory storage) includes a machine-readable medium 622 on which is stored one or more sets of data structures and instructions 624 (e.g., software) embodying or utilized by any one or more of the methodologies or functions described herein. The data structures and instructions 624 may also reside, completely or at least partially, within the main memory 604, the static memory 606, and/or within the processor 602 during execution thereof by processing system 600, with the main memory 604 and processor 602 also constituting machine-readable, tangible media.

The data structures and instructions 624 may further be transmitted or received over a computer network 650 via network interface device 620 utilizing any one of a number of well-known transfer protocols (e.g., Hypertext Transfer Protocol (HTTP)).

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., the processing system 600) or one or more hardware modules of a computer system (e.g., a processor 602 or a group of processors) may be configured by software (e.g., an application or application portion) as a hardware module that operates to perform certain operations as described herein.

In various embodiments, a hardware module may be implemented mechanically or electronically. For example, a hardware module may include dedicated circuitry or logic that is permanently configured (for example, as a special-purpose processor, such as a field-programmable gate array (FPGA) or an application-specific integrated circuit (ASIC)) to perform certain operations. A hardware module may also include programmable logic or circuitry (for example, as encompassed within a general-purpose processor 602 or other programmable processor) that is temporarily configured by software to perform certain operations. It will be appreciated that the decision to implement a hardware module mechanically, in dedicated and permanently configured circuitry, or in temporarily configured circuitry (for example, configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules include a general-purpose processor 602 that is configured using software, the general-purpose processor 602 may be configured as respective different hardware modules at different times. Software may accordingly configure a processor 602, for example, to constitute a particular hardware module at one instance of time and to constitute a different hardware module at a different instance of time.

Modules can provide information to, and receive information from, other modules. For example, the described modules may be regarded as being communicatively coupled. Where multiples of such hardware modules exist contemporaneously, communications may be achieved through signal transmissions (such as, for example, over appropriate circuits and buses) that connect the modules. In embodiments in which multiple modules are configured or instantiated at different times, communications between such modules may be achieved, for example, through the storage and retrieval of information in memory structures to which the multiple modules have access. For example, one module may perform an operation and store the output of that operation in a memory device to which it is communicatively coupled. A further module may then, at a later time, access the memory device to retrieve and process the stored output. Modules may also initiate communications with input or output devices, and can operate on a resource (for example, a collection of information).

The various operations of example methods described herein may be performed, at least partially, by one or more processors 602 that are temporarily configured (e.g., by software) or permanently configured to perform the relevant operations. Whether temporarily or permanently configured, such processors 602 may constitute processor-implemented modules that operate to perform one or more operations or functions. The modules referred to herein may, in some example embodiments, include processor-implemented modules.

Similarly, the methods described herein may be at least partially processor-implemented. For example, at least some of the operations of a method may be performed by one or more processors 602 or processor-implemented modules. The performance of certain of the operations may be distributed among the one or more processors 602, not only residing within a single machine but deployed across a number of machines. In some example embodiments, the processors 602 may be located in a single location (e.g., within a home environment, within an office environment, or as a server farm), while in other embodiments, the processors 602 may be distributed across a number of locations.

While the embodiments are described with reference to various implementations and exploitations, it will be understood that these embodiments are illustrative and that the scope of claims provided below is not limited to the embodiments described herein. In general, the techniques described herein may be implemented with facilities consistent with any hardware system or hardware systems defined hereto. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the claims. In general, structures and functionality presented as separate components in the exemplary configurations may be implemented as a combined structure or component. Similarly, structures and functionality presented as a single component may be implemented as separate components. These and other variations, modifications, additions, and improvements fall within the scope of the claims and their equivalents.

What is claimed is:

1. A method, comprising:
displaying, in a first area of a display, a plurality of first graphical objects representing processing requests, each of the first graphical objects presenting first information concerning the corresponding processing request;
displaying, in a second area of the display that is different from the first area, in response to selection of more than one of the first graphical objects, a plurality of second graphical objects corresponding to the selected first graphical objects, each of the second graphical objects presenting second information concerning the processing request of the corresponding first graphical object, the second information having a level of detail greater than a level of detail of the first information of the corresponding first graphical object;
displaying a user-selectable region associated with the second graphical objects; and
servicing, by at least one processor of a machine, in response to a user selection of the user-selectable region, the processing requests associated with the second graphical objects.

2. The method of claim 1, at least one of the selected first graphical objects being selected by default without user input.

3. The method of claim 1, the plurality of first graphical objects being selectable by a user, and at least one of the selected first graphical objects being selected by the user.

4. The method of claim 1, the displaying of the user-selectable region occurring in the second area of the display.

5. The method of claim 1, further comprising:
displaying, in conjunction with the user-selectable region, an indication of a number of the second graphical objects.

6. The method of claim 1, further comprising:
displaying, in conjunction with the user-selectable region, a second user-selectable region to decline to service the processing requests associated with the second graphical objects.

7. The method of claim 1, the first graphical objects being arranged in the first area as a list.

8. The method of claim 1, the second graphical objects, appearing in the second area as overlapping documents.

9. The method of claim 1, the first information concerning the corresponding processing request comprising at least one of a requester of the corresponding processing request, a date of the corresponding processing request, a time of the corresponding processing request, and a title of the corresponding processing request, and the second information concerning the corresponding processing request comprising a description of the corresponding processing request.

10. The method of claim 1, each of the processing requests comprising a request for approval of a proposed action by a party, and the servicing of the processing requests comprising approving the processing requests.

11. The method of claim 10, the proposed action comprising a proposed purchase, the method further comprising displaying, in conjunction with the user-selectable region, a total amount of the proposed purchases associated with the second graphical objects.

12. The method of claim 1, further comprising:
displaying, in response to a user selection of one of the second graphical objects, a third graphical object presenting third information concerning the processing request of the corresponding first graphical object and having a level of detail greater than a level of detail of the second information of the corresponding second graphical object.

13. The method of claim 12, the displaying of the third graphical object comprising overlaying the third graphical object over at least one of the first area and the second area.

14. The method of claim 12, further comprising:
displaying a second user-selectable region in conjunction with the third graphical object; and
servicing, in response to a user selection of the second user-selectable region, the processing request associated with the third graphical object.

15. The method of claim 14, further comprising:
displaying, in conjunction with the third graphical object, a third user-selectable region to decline to service the processing request associated with the third graphical object.

16. A non-transitory computer-readable storage medium comprising instructions that, when executed by at least one processor of a mobile communication device, cause the mobile communication device to perform operations comprising:
displaying, in a first area of a display of the mobile communication device, a plurality of first graphical objects representing processing requests, each of the first graphical objects presenting first information concerning the corresponding processing request;
displaying, in a second area of the display that is different from the first area, in response to selection of more than one of the first graphical objects, a plurality of second graphical objects corresponding to the selected first graphical objects, each of the second graphical objects presenting second information concerning the processing request of the corresponding first graphical object, the second information having a level of detail greater than a level of detail of the first information of the corresponding first graphical object;
displaying a user-selectable region associated with the second graphical objects; and
servicing, in response to a user selection of the user-selectable region, the processing requests associated with the second graphical objects.

17. The non-transitory computer-readable storage medium of claim 16, the plurality of first graphical objects being selectable by a user, and at least one of the selected first graphical objects being selected by the user.

18. A mobile communication device, comprising:
a visual display component;
at least one processor; and
a memory storing modules comprising instructions to be executed by the at least one processor, the modules comprising:
a processing request interface module configured to receive a plurality of processing requests from a computing system external to the mobile communication device; and
a processing request presentation module configured to:
display, in a first area of the visual display component, a plurality of first graphical objects representing processing requests, each of the first graphical objects presenting first information concerning the corresponding processing request;
display, in a second area of the visual display component that is different from the first area, in response to selection of more than one of the first graphical objects, a plurality of second graphical objects corresponding to the selected first graphical objects, each of the second graphical objects presenting second information concerning the processing request of the corresponding first graphical object, the second information having a level of detail greater than a level of detail of the first information of the corresponding first graphical object; and
displaying a user-selectable region associated with the second graphical objects;
the processing request interface module further configured to indicate, in response to a user selection of the user-selectable region, servicing of the processing requests associated with the second graphical objects to the computing system.

19. The mobile communication device of claim 18, the processing request presentation module further configured to:
display, in response to a user selection of one of the second graphical objects, a third graphical object presenting third information concerning the processing request of the corresponding first graphical object and having a level of detail greater than a level of detail of the second information of the corresponding second graphical object.

20. The mobile communication device of claim 18, the processing request presentation module further configured to display, in conjunction with the third graphical object, a second user-selectable region to service the processing request associated with the third graphical object; and
the processing request interface module further configured to indicate, in response to a user selection of the second user-selectable region, servicing of the processing request associated with the third graphical object to the computing device.
